(19) United States
(12) Patent Application Publication
(10) Pub. No.: US 2006/0276211 A1
(43) Pub. Date: Dec. 7, 2006

(54) Radio communication system

(76) Inventor: Francesco Gallo, Aachen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/567,043

(22) PCT Filed: Aug. 2, 2004
(86) PCT No.: PCT/IB04/51354

§ 371 Date: Feb. 2, 2006

(30) Foreign Application Priority Data
Aug. 11, 2003 (EP) 03102496.1

(51) Int. Cl. H04B 7/00; H04Q 7/20

(52) U.S. Cl. 455/507

(57) ABSTRACT

Bluetooth radio communication systems (1,2) are made more dynamic by providing master units (3) with processor systems (32) having user interface applications (81), profile applications (83,84) and manager applications (82) for providing interfaces to the user interface applications (81), for managing the profile applications (83,84) and for searching for and retrieving information from one or more slave units (4-7). The manager applications (82) are in the form of intermediate layers between user interface layers and profile layers. The retrieved information comprises identification information and profile information. The profile applications (83,84) comprise headset (84) and/or intercom (83) profile applications. The manager applications (82) comprise state machines with idle states (100), search states (110), connection request states (120) and connection respond states (130). The master units (3) comprise man-machine-interfaces (34) with two selection buttons and one or more arrow buttons. As a result, slave units (4-7) as well as their profile applications do not need to be known to the master units (3) beforehand.

The invention relates to a radio communication system, and also relates to a master unit, a processor system, a method and a processor program product.

Such a radio communication system comprising one or more master units and one or more slave units for example corresponds with a Bluetooth system.

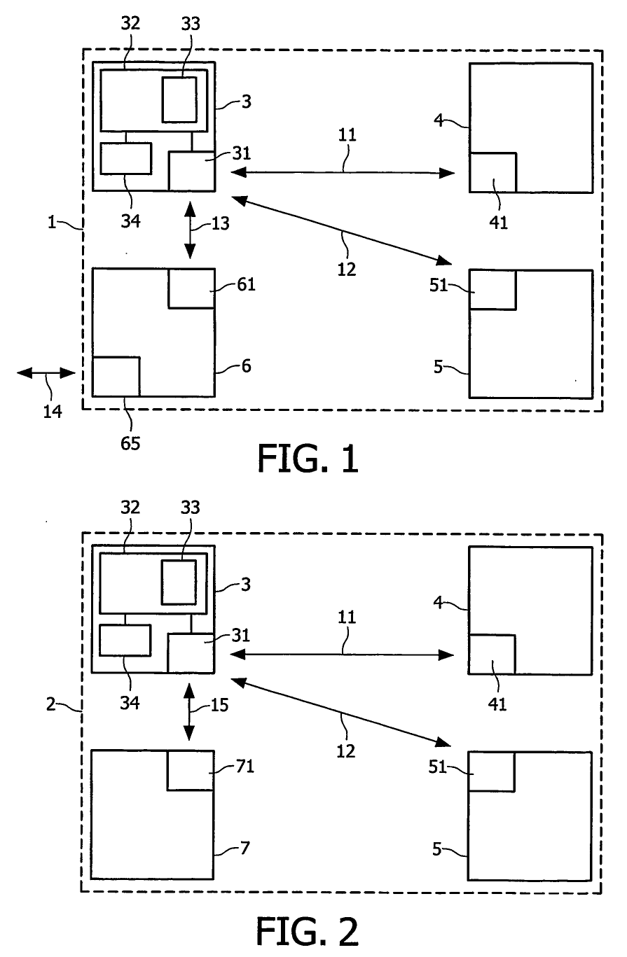

A prior art system is known from U.S. Pat. No. 6,405,027 B1, which discloses in its FIG. 1A a Bluetooth system comprising a Bluetooth enabled handset and Bluetooth enabled communication devices. The Bluetooth enabled handset comprises a processor system as shown in its FIG. 2. This Bluetooth system is based on one single profile application, the Bluetooth Intercom Profile (Bluetooth Telephony Profile). This profile application defines the kind of audio communication possible between the master unit and the slave unit.

The known radio communication system is disadvantageous, inter alia, due to the slave units as well as their profile application needing to be known to the master unit beforehand.

It is an object of the invention, inter alia, of providing a radio communication system in which the slave units as well as their profile application do not need to be known to the master unit beforehand.

Furthers objects of the invention are, inter alia, providing a master unit and a processor system for use in a radio communication system in which the slave units as well as their profile application do not need to be known to the master unit beforehand, and providing a method and a processor program product for use in (combination with) a radio communication system in which the slave units as well as their profile application do not need to be known to the master unit beforehand.

The radio communication system according to the invention comprises at least one master unit and at least one slave unit, which master unit comprises a processor system with a user interface application; a profile application; and a manager application for—providing an interface to the user interface application; —managing the profile application; and—searching for and retrieving information from one or more slave units.

By providing the processor system with the manager application, for example in the form of an intermediate layer between a user interface layer and a profile layer, the manager application can search for slave units and retrieve information from any slave units found. The retrieved information for example comprises identification information for identifying the slave units found, which identification information can be easily processed by the manager application, due to this manager application communicating directly with the user interface application (providing an interface to this user interface application), without the slave units found needing to be known to the master unit beforehand. The retrieved information further for example comprises profile information for defining the profile applications of the slave units found, which profile information can be easily processed by the manager application, due to this manager application communicating directly with the profile application (controlling the profile application), without the profile applications of the slave units found needing to be known to the master unit beforehand.

A first embodiment of the system according to the invention is defined by the profile application comprising a headset profile application, with the manager application being adapted to set up and finish a connection with a slave unit for example comprising an audio gateway or, more general, a headset profile application. The headset profile application is defined in “Specification of the Bluetooth system”, version 1.1, Feb. 22, 2001, page 197 and further, and allows a slave unit to communicate with a master unit via the headset profile application.

A second embodiment of the system according to the invention is defined by the profile application comprising an intercom profile application, with the manager application being adapted to set up and finish a connection with a slave unit comprising an intercom. The intercom profile application is defined in “Specification of the Bluetooth system”, version 1.1, Feb. 22, 2001, page 145 and further, and allows a slave unit in the form of an intercom to communicate with a master unit.

A third embodiment of the system according to the invention is defined by the manager application being further adapted to join the headset profile application and the intercom profile application. By joining both profile applications (combining both profile applications such that both together form one layer), the master unit can switch between both profile applications easily.

A fourth embodiment of the system according to the invention is defined by the manager application comprising a state machine comprising an idle state, a search state, a connection request state and a connection respond state. Such a state machine is easy to implement, with the search state being used for searching for and retrieving information from one or more slave units, and with the connection request state being used for initiating a connection, and with the connection respond state being used for responding to a connection initiative from a slave unit.

A fifth embodiment of the system according to the invention is defined by the master unit comprising a man-machine-interface with at least two selection buttons and one or more arrow buttons. The two selection buttons for example comprise an ok-button (go-forward, select) for going deeper in a menu or for selecting a part of the menu and a c-button (go-back, deny) for going back in the menu or for not-selecting a part of the menu, with one or two arrow buttons (go-up, go-down, go-left, go-right) being used for going through the menu etc. Preferably, the man-machine-interface further comprises a display etc.

The terms “manager application” and “profile application” and “user interface application” may correspond with “manager function” and “profile function” and “user interface function” respectively.

Embodiments of the master unit according to the invention and of the processor system according to the invention and of the method according to the invention and of the processor program product according to the invention correspond with the embodiments of the radio communication system according to the invention.

The invention is based upon an insight, inter alia, that a radio communication system in which the slave units as well as their profile application need to be known to the master unit beforehand is relatively static, and is based upon a basic idea, inter alia, that the radio communication system can be made more dynamic by introducing the manager application for—providing an interface to the user interface application; —managing the profile application; and —searching for and retrieving information from one or more slave units.

The invention solves the problem, inter alia, of providing a radio communication system in which the slave units as well as their profile application do not need to be known to the master unit beforehand, and is advantageous, inter alia, in that such a radio communication system is more dynamic.

These and other aspects of the invention will be apparent from and elucidated with reference to the embodiments(s) described hereinafter.

In the drawings:

FIG. 1 shows in block diagram form a first radio communication system according to the invention comprising one master unit according to the invention and three slave units;

FIG. 2 shows in block diagram form a second radio communication system according to the invention comprising one master unit according to the invention and three slave units;

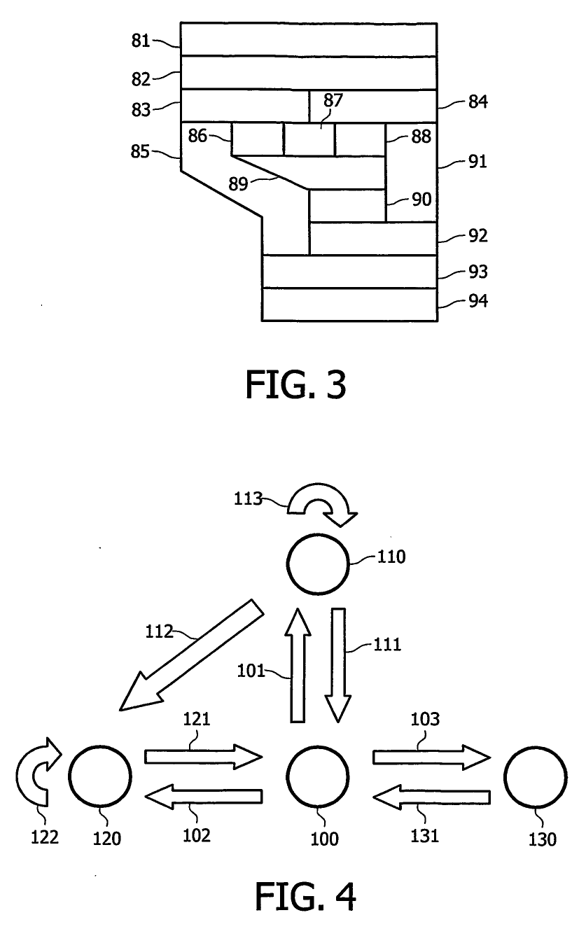

FIG. 3 shows a layer overview for a master unit according to the invention and comprising a manager application in the form of an intermediate layer between a user interface layer and a profile layer;

FIG. 4 shows an idle state, a search state, a connection request state and a connection respond state of a state machine forming part of the manager application;

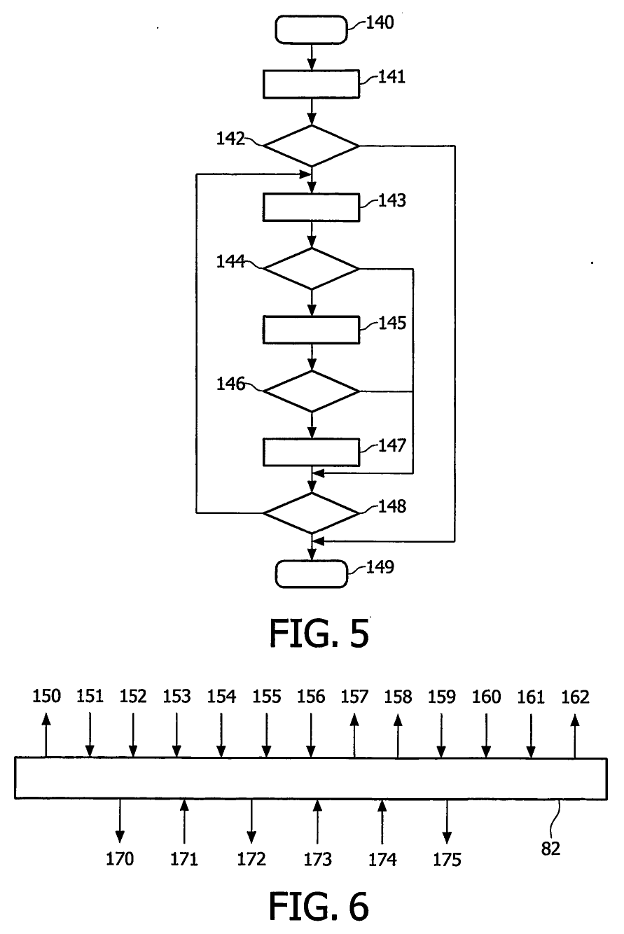

FIG. 5 shows a flow chart for searching for and retrieving information from one or more slave units; and

FIG. 6 shows a manager application and its application program interfaces and lower primitives.

The first radio communication system 1 according to the invention shown in FIG. 1 comprises one master unit 3 according to the invention and three slave units 4-6. Master unit 3 comprises a transceiver 31 like for example Bluetooth hardware and comprises a processor system 32 according to the invention comprising a processor program product 33 according to the invention and coupled to the transceiver 31 and to a man-machine-interface or mmi 34. Slave unit 4 comprises a transceiver 41 like for example Bluetooth hardware and for example comprises an intercom, with connection 11 between transceivers 31 and 41 then for example being based on a Bluetooth intercom profile. Slave unit 5 comprises a transceiver 51 like for example Bluetooth hardware and for example comprises an intercom, with connection 12 between transceivers 31 and 51 then for example being based on a Bluetooth intercom profile. Slave unit 6 comprises a transceiver 61 like for example Bluetooth hardware and for example comprises a cellular phone with an audio gateway or, more general, a headset profile application, with connection 13 between transceivers 31 and 61 then for example being based on a Bluetooth headset profile. Slave unit 6 further comprises a transceiver 65 for cellular communication with a base station or node not shown via a connection 14.

The second radio communication system 2 according to the invention shown in FIG. 1 comprises one master unit 3 according to the invention as described before and three slave units 4 and 5 as described before and slave unit 7. Slave unit 7 comprises a transceiver 71 like for example Bluetooth hardware and for example comprises an intercom, with connection 15 between transceivers 31 and 71 then for example being based on a Bluetooth intercom profile.

The layer overview shown in FIG. 3 for a master unit 3 according to the invention comprises a manager application in the form of an intermediate layer 82 between a user interface application in the form of user interface layer 81 and a profile application in the form of a profile layer 83,84. Profile layer 83 for example corresponds with an intercom profile layer (intercom profile application) or smart profile layer (smart profile application) based on the intercom profile layer (application), and profile layer 84 for example corresponds with a headset profile layer (headset profile application). Layer 85 is an audio layer, layer 86 is a service discovery protocol layer, layer 87 is a telephony control specification layer, layer 88 is a serial cable emulation protocol layer, layer 89 is a data layer, layer 90 is a logical link control and adaptation protocol layer, layer 91 is a control layer, layer 92 is a link manager layer, layer 93 is a baseband layer and link 94 is a radio frequency layer. Layers 83-94 are for example Bluetooth layers disclosed in Bluetooth specifications. For example the headset profile application in the form of the headset profile layer is defined in “Specification of the Bluetooth system”, version 1.1, Feb. 22, 2001, page 197 and further, and the intercom profile application in the form of the intercom profile layer is defined in “Specification of the Bluetooth system”, version 1.1, Feb. 22, 2001, page 145 and further, etc. The layers 81-94 for example schematically correspond with functions of the processor program product 33 and transceiver 31. Each layer may correspond with (a part of) an application and/or with (a part of) a function.

The idle state 100, the search state 110, the connection request state 120 and the connection respond state 130 as shown in FIG. 4 of a state machine forming part of the manager application 82 are used as follows.

In the idle state 100, the manager application is waiting for events or commands. The following transitions for the idle state 100 are possible. From idle state 100 to search state 110, transition 101 takes place in response to a (higher) search procedure request command or a (higher) shortcut search procedure request command originating from the user interface application, or takes place periodically without any command being generated. From idle state 100 to connection request state 120, transition 102 takes place in response to a (higher) connection request command originating from the user interface application. From idle state 100 to connection respond state 130, transition 103 takes place in response to a (lower) connection indication event originating from a slave unit which has sent a connection request command.

In the search state 110, the manager application 82 is searching for slave units. The following transitions for the search state 110 are possible. From search state 110 to idle state 100, transition 111 takes place in response to the finishing of the search procedure 113, or takes place in response to a (higher) search procedure stop command originating from the upper layer. In both cases, a (higher) search procedure complete event is generated and supplied to the upper layer. From search state 110 to connection request state 120, transistion 112 takes place in case of the search procedure having found at least one slave unit in response to the (higher) shortcut search procedure request command described before. The (higher) search procedure complete event is generated and supplied to the upper layer, and a (lower) connection request command is generated and supplied to the lower layer.

In the connection request state 120, the manager application 82 is establishing a new connection to a slave unit 4-7. From the connection request state 120 to the idle state 100, transition 121 takes place in response to a (lower) connection confirmation event 122. The (higher) connection complete event is generated and supplied to the upper layer.

In the connection respond state 130, the manager application 82 has received a (lower) connection indication event, and is establishing a new connection. From the connection respond state 130 to the idle state 100, transition 131 takes place in response to a (lower) connection respond command being sent to the lower layer. The (higher) connection complete event is generated and supplied to the upper layer.

The manager application 82 is responsible for controlling the Bluetooth transceiver 31 and the Bluetooth connections 11,12,13,15 according to commands from the user interface application 81 and events from the lower layers 83,84. The manager application 82 performs the following actions:

According to user commands it can start or stop the search procedure.

According to user commands it can start the search procedure called “Shortcut Search Procedure”. In fact the manager application 82 can establish a synchronous connection oriented link between the master unit and the discovered slave unit without starting a paging procedure but exploiting the pre-existent connection created from a search procedure. An example of utilisation of this “shortcut” connection could be a scenario when the smart intercom master unit is near to only one slave unit.

According to user commands it can start the search procedure periodically with the period set via the user interface, it is called “Periodical Search Procedure”.

The manager application 82 has to manage incoming user interface commands and lower layer events from lower layers 83,84 etc. The manager application 82 has to send commands to lower layers and events to upper layers.

When more synchronous connection oriented links are established the manager application 82 can select one or more synchronous connection oriented links to listen to at the same time by means of for example headphones.

The flow chart as shown in FIG. 5 for searching for and retrieving information from one or more slave units comprises blocks 140-148 which have the following meaning:

Block 140: Start, goto 141;

Block 141: Inquiry, goto 142;

Block 142: Are slave units found ? If yes, goto 143, if no, goto 149;

Block 143: Page, goto 144;

Block 144: Is the slave unit connected ? If yes, goto 145, if no, goto 148;

Block 145: Service discovery protocol, goto 146;

Block 146: Is a profile found ? If yes, goto 147, if no, goto 148;

Block 147: Save/update list, goto 148;

Block 148: Are no other slave units to be paged ? If yes, goto 149, if no, goto 143;

Block 149: Stop.

The search procedure is as follows. It is started in case a master unit 3 wants to discover the near slave units 4-7. Every time a new slave unit 4-7 is discovered a new row is inserted in the list as shown in the table. If the discovered slave unit 4-7 is already present in the list, the corresponding row is updated. The list contains all relevant information about all discovered slave units. The data can be retrieved using inquiry (Bluetooth device address), name request (nickname), and service discovery protocol (profile, and phone number).

| | | | | | | Expiry |
|---|---|---|---|---|---|---|
| # | Address | Profile | Nickname | Phone | Status | Timeout |
| 1 | 0050CD000376 | Smart | Joan | 2341 | Connected | None |
| 2 | 0033EF000385 | Headset | Franc. | None | Not | None |
| | | | Phone | | Connected | |
| 3 | 0050CD000377 | Smart | Javier | 2343 | Not | 3600 s |
| | | | | | Connected | |
| 4 | 0034EF003456 | None | — | — | Not | None |
| | | | | | Connected | |

The meaning of each column is described below:

#: Row number.

Address: Bluetooth device address.

Profile: Supported profile on the slave unit. If a slave unit supports two profiles

(smart profile and headset profile, with the smart profile being based on the intercom profile) two rows in the list will be inserted.

Nickname: user-friendly name of the slave unit (user).

Phone: phone number used in the smart profile of the slave unit.

Status: it shows if the slave unit is connected or not with the master unit.

Expiry Timeout: it shows when the row will be removed from the list. Expiry Timeout is used to avoid that the list grows unduly. It is updated every time the slave unit is discovered, and it is disabled when the Status is “Connected”. The user can set the Expiry Timeout value. The default value is 3600 seconds (1 hour).

The manager application 82 shown in FIG. 6 is controlled by the user interface application 81 via application program interfaces (api's) 150-162 (with at least some of these api's providing (a part of) an interface to the user interface application 81) and controls the headset profile application 84 and the intercom profile application 83 via lower primitives (lpr's) 170-175, which api's have the following meaning:

Api 150: (higher) search procedure complete (row 1, row 2, . . . )—this event is generated at the end of each search procedure to the user interface application 81; the returned parameters are the row number of new discovered slave unit in the list; the user interface can retrieve the information of discovered slave units using the (higher) get list command;

Api 151: (higher) search procedure request (period)—the user interface application 81 sends this command to start the search procedure to took for new slave unit; if Period=0 the search procedure is done once, if Penod=T seconds the search procedure is repeated periodically every T seconds until a (higher) search procedure stop is received;

Api 152: (higher) shortcut search procedure request (type-of-device)—the user interface application 81 sends this command to start the search procedure; if at least one slave unit is discovered, the manager application 82 will establish a new connection sending immediately a (lower) connection request; the parameter type-of-device specifies which type of profile will be used, the possible values are: smart profile, headset profile and all (both smart profile and headset profile); in case the discovered slave unit does not support the profile specified on type-of-device the connection will not be made;

Api 153: (higher) search procedure stop—the user interface application 81 sends this command to stop the search procedure;

Api 154: (higher) set attribute (attribute, parameter1, parameter2, . . . )—this command sets the attributes of the manager application 82 as listed below; the policy attribute specifies the allowed incoming connections; the expiry sets the expiry timeout in the list for a particular slave unit specified by the row number; the pairing attribute is set when a PIN number is requested from a slave unit or from the master unit; for both cases the row number specifies the slave unit in the list; every time a (higher) set attribute command is sent, the user interface must wait to be sure that the command was not refused and that the PIN number is correct.

| Attribute | | Parameter | |
|---|---|---|---|
| ID | Parameter | Values | Description |
| Policy | Type of | Accept headset | Accept all incoming connections |
| | Policy | profile | that use headset profile |
| | | Accept smart | Accept all incoming connections |
| | | profile | that use smart profile |
| | | Accept all | Accept all incoming connections |
| | | | that use headset and smart |
| | | | profile |
| | | No accept | Do not accept connections |
| Expiry TO | Row # | N > 0 | Row number in the list |
| | Timeout | 0 | Infinite expire timeout, Expiry |
| | | | TO never expires |
| | | T > 0[s] | Expire timeout is set to T |
| | | | seconds |
| Pairing | PIN | X | X is the PIN number of 128bits |
| | Row # | N > 0 | Row number in the list |

Api 155/156: (higher) remove/add voice stream (row, profile)—these commands select the voice streams via the connections; every time this command is sent, the user interface application 81 must wait to be sure that the command has not been refused;

Api 157: (higher) command event (event, parameter)—this event is returned to the upper layer to notify that a command has been received, as shown below;

| | | Parameter | |
|---|---|---|---|
| Event ID | Parameter | Values | Description |
| (higher) set | Status | Accepted | The command is accepted |
| attibutes | | | |
| | | Refused | An error is occurred, command |
| | | | refused |
| (higher) | Status | Accepted | The command is accepted |
| remove/add | | | |
| voice stream | | | |
| | | Refused | An error is occurred, command |
| | | | refused |
| Pairing PIN | Status/row | >0 | Row number in the list of the |
| | | | slave unit requesting the pairing |
| | | <0 | PIN rejected |
| | | =0 | PIN accepted |

Api 158: (higher) connection complete (row, status)—two parameters are used in this event; the first is the row (row number) in the list; the second is the status of the connection establishment, it may have the following values: accepted, disconnected or refused. The event is returned in two cases: when a (lower) connection indication arrives, and after the reception of a (lower) connection confirmation; in case the master unit accepts, the status becomes accepted, and otherwise becomes refused; when a connection is closed, the status becomes disconnected, and the manager application 82 will send a (higher) connection complete event to the upper layer;

Api 159: (higher) connection request (row)—the user interface application 81 sends this command to start the connection establishment with the slave unit specified by the row number in the list;

Api 160: (higher) disconnection request (row)—the user interface application 81 sends this command to release the connection with the slave unit specified by the row number in the list;

Api 161: (higher) get list (row 1, row 2, . . . )—using this api the user interface application 81 can retrieve all or several rows of the list (row 1, row 2, . . . ); In case no parameters are specified, the command returns the complete list; in case parameters are specified, it is possible to get only several list rows;

Api 162: (higher) list (row list 1, row list 2, . . . )—this event returns the requested rows of the list specified on the (higher) get list command;

For the smart profile 83 based on the intercom profile, the lpr's have the following meaning:

Lpr 170: (lower) connection request (list row)—this command is sent from the manager application 82 to the intercom profile application or smart profile application 83 to establish an intercom connection (call request, call confirmation, and call connection) in the outgoing unit (caller, the unit that requests the connection); the profile application 83 will receive a complete list that describes the slave unit (list row parameter); if the slave unit is already connected (due to a (higher) shortcut search procedure request) only a connection-oriented logical link control and adaptation protocol channel will be created, otherwise a paging procedure will be performed toward the address specified in the list row as well; no service discovery protocol operation will be done in the outgoing unit that requests the connection;

Lpr 171: (lower) connection confirmation (status)—this event is sent from the profile application 83 to the manager application 82 in the outgoing unit; the meaning of the status parameter is the same as the meaning of the next primitive lpr 172; if status is equal to connection accepted, this means that the call request has been accepted and the profile application 83 will start the call confirmation and the call connection; otherwise the status is equal to connection refused, which means that the call request has been refused and the profile application will start the call clearing;

Lpr 172: (lower) connection response (status)—according to the policy the manager application 82 will manage the (lower) connection indication event and will send this command to the ingoing unit; the status parameter can take two values if the connection request is accepted or not, connection accepted and connection refused; in the former the profile application 83 will perform the call request, the call confirmation, and the call connection; in the latter the profile application 83 will start a call clearing;

Lpr 173: (lower) connection indication (list row)—this event is sent from the profile application 83 to the manager application 82 during the call request in the ingoing unit (called, the unit that receives the connection request); the list row parameter is a list row with the information of the outgoing unit; all list fields are retrieved using the service discovery protocol, and remote name request at the ingoing unit during the call request;

Lpr 174: (lower) disconnection (list row)—this event is sent every time the connection is dosed for any reason during the call request, the call confirmation, and the call connection; the list row parameter is a list row with the information of the disconnected remote unit; when the manager application 82 receives this message from the profile application 83, it will send a higher) connection complete with status equal to disconnected, and row being equal to list row;

Lpr 175: (lower) connection release (list row)—this command is sent from the manager application 82 to the profile application 83 every time a (higher) disconnection request comes from the upper layer; the list row parameter is a list row with the information of the remote unit that will be disconnected; list row is equal to the row parameter of the (higher) disconnection request; after having received this message the profile application 83 will perform a call clearing.

For the headset profile 84, the lpr's have the following meaning:

Lpr 170: (lower) connection request (list row)—this command is sent from the manager application 82 to the headset profile application 84 to establish a connection with the slave unit; if the slave unit is already connected (due to a shortcut search procedure request) only a connection-oriented logical link control and adaptation. protocol channel and a radio frequency connection will be created, otherwise a paging procedure will be performed toward the address specified in the list row as well. No service discovery protocol operation will be done in the master unit;

Lpr 171: (lower) connection confirmation (status)—this event is sent from the headset profile application 84 to the manager application 82; the meaning of the status parameter is the same as the next primitive lpr 172; if status is equal to connection accepted it means that the connection is being established; otherwise status is equal to connection refused, which means that the connection is refused and the the headset profile application 84 will close the connection establishment.

Lpr 172: (lower) connection response (status)—according to the policy, the manager application 82 will manage the (lower) connection indication event and it will send this command to the headset profile application 84; the status parameter can take two values for the connection request being accepted or not: connection accepted and connection refused;

Lpr 173: (lower) connection indication (list row)—this event is sent from the headset profile application 84 to the manager application 82; the list row parameter is a list row; all list fields are retrieved using the service discovery protocol and remote name request during the connection establishment;

Lpr 174: (lower) disconnection (list row)—this event is sent every time the connection is closed for any reason during the connection; the list row parameter is a list row with the information of the disconnected slave unit; when the manager application receives this message from the headset profile application 84, it will send a (higher) connection complete with status equal to disconnected, and with row being equal to list row.

Lpr 175: (lower) connection release (list row)—this command is sent from the manager application 82 to the headset profile application 84 every time a (higher) disconnection request comes from the upper layer; the list row parameter is a list row with the information of the slave unit that will be disconnected; list row is equal to row parameter of (higher) disconnection request; after having received this message the headset profile application 84 will perform an audio connection release.

The man-machine-interface or mmi 34 for example comprises two selection buttons and two arrow buttons. The two selection buttons for example comprise an OK button (go-forward, select) for going deeper in a menu or for selecting a part of the menu and a C button (go-back, deny) for going back in the menu or for not-selecting a part of the menu, with two arrow buttons (go-up, go-down, go-left, go-right) being used for going through the menu etc. Preferably, the mmi 34 further comprises a display etc.

With the four buttons the user can turn on/off the master unit, search slave units, establish a connection, save/delete a slave unit in the list, perform the pairing (exchange of PIN code) etc. The procedures to perform the previous actions are described below:

1. To switch ON/OFF, the C button is to be pressed for a few seconds.

2. When the master unit is ON, it is possible to select a list row (if there are slave unit rows that have been saved), the “Normal/Shortcut/Periodic Search” (procedure) using the up/down arrows, and the “Policies” of the manager application. The list rows are named using the nickname, the phone number, or the address.

3. To establish a connection, the list row item is to be selected and the OK button is to be pressed. To stop the procedure, the C button is to be pressed. If the slave unit or the master unit requires the pairing, the PIN number has to be inserted. To enter the PIN number, the up/down arrows are used to change a single digit from 0 to 9. The OK button is to be pressed to confirm the current digit and to change to the next one; the C button is for going back.

4. To establish a connection requested from a slave unit, firstly the master unit will firstly inform the user by means of sensitized voice (or the display will change) and secondly it will establish the link upon pushing the OK button. Pressing the C button will refuse the connection establishing. If the slave unit or the master unit requires the pairing, the PIN number has to be inserted. Finally the new slave unit will be added to the list.

5. To close a connection, the corresponding list row is to be selected by means of the up/down arrows. Then the C button is to be pressed.

6. To request pairing (PIN request), and to save/delete a list row, the list row is to be selected and the C button is to be pressed. Then “Pairing”, “Save”, or “Delete” items is to be selected using the up/down arrows and the OK button is to be pressed. If “Pairing” is selected, enter the PIN number. The next time that the corresponding list row will be chosen to establish a connection, the pairing procedure will be performed and on the slave unit the PIN number will be requested. To save/delete a list row item, “Save” or “Delete” item is to be selected and the OK button is then to be pressed.

7. To perform a search procedure, the “Normal Search” is to be selected and the OK button is to be pressed. Otherwise the “Shortcut Search” or “Periodical Search” is to be selected, and the C button is to be pressed, then the “Normal” item is to be selected and the OK button is to be pressed. Over “Normal Search” the OK button is to be pressed. To stop the search procedure the C button is to be pressed.

8. To perform a shortcut search procedure, the “Shortcut Search” is to be selected and the OK button is to be pressed, otherwise etc.

9. To perform a periodic search procedure, the “Periodic Search” is to be selected and the OK button is to be pressed, otherwise etc.

10. To set the Smart Intercom Device Policies, the “Policies” item is to be selected by pressing the OK button, then the most appropriate policies are to be selected with the up/down arrows and are to be confirmed with the OK button.

10a. “Accept All Connection”: accept all incoming connections, with a headset profile or a smart profile.

10b. “Accept Smart Profile”; accept all incoming connections that use the smart profile.

10c. “Accept Headset Profile”: accept all incoming connections that use the headset profile.

10d. “Refuse All Connection”: refuse all connections.

11. To add/remove an audio stream already established, the corresponding list row is to be selected and the OK button is to be pressed. It is possible to listen to three connections at the same time.

On items number 3, 4, and 6, if the PIN number is wrong, it will be requested up to three times. In case the third time the PIN is still wrong the connection will be closed. Every time a normal/shortcut/periodic search procedure is performed the list is updated with the new discovered slave units. The new items will appear on the list (and it will be possible to select the items using the up/down arrows) but they will not be saved, that is, they will disappear from the list when the master unit is switched OFF. Each time the up/down arrows, and OK/C buttons are pressed, from the headphones a sensitized voice will say which function or action (device row, search procedure, item) is selected.

Master units may alternatively be used as slave units, and slave units, if sufficiently equipped, may alternatively be used as master units. There will always be one master unit and one or more slave units Especially, but not exclusively, the invention can be advantageously used in a motorbike environment for allowing communication between motorbikers and/or passengers.

The expression “for” in for example “for A” and “for B” does not exclude that other functions “for C” are performed as well, simultaneously or not. The expressions “X coupled to Y” and “a coupling between X and Y” and “coupling/couples X and Y” etc. do not exclude that an element Z is in between X and Y. The expressions “P comprises Q” and “P comprising Q” etc. do not exclude that an element R is comprised/included as well.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The invention is based upon an insight, inter alia, that a radio communication system in which the slave units as well as their profile application need to be known to the master unit beforehand is relatively static, and is based upon a basic idea, inter alia, that the radio communication system can be made more dynamic by introducing the manager application for—providing an interface to the user interface application; —managing the profile application; and—searching for and retrieving information from one or more slave units.

The invention solves the problem, inter alia, of providing a radio communication system in which the slave units as well as their profile application do not need to be known to the master unit beforehand, and is advantageous, inter alia, in that such a radio communication system is more dynamic.

1. Radio communication system (1,2) comprising at least one master unit (3) and at least one slave unit (4-7), which master unit (3) comprises a processor system (32) with a user interface application (81); a profile application (83,84); and a manager application (82) for—providing an interface to the user interface application (81);
managing the profile application (83,84); and —searching for and retrieving information from one or more slave units (4-7).

2. Radio communication system (1,2) as claimed in claim 1, wherein the profile application (84) comprises a headset profile application, with the manager application (82) being adapted to set up and finish a connection with a slave unit (6).

3. Radio communication system (1,2) as claimed in claim 1, wherein the profile application (83) comprises an intercom profile application, with the manager application (82) being adapted to set up and finish a connection with a slave unit (4,5,7) comprising an intercom.

4. Radio communication system (1,2) as claimed in claim 2, wherein the manager application (82) is further adapted to join the headset profile application and the intercom profile application.

5. Radio communication system (1,2) as claimed in claim 1, wherein the manager application (82) comprises a state machine comprising an idle state (100), a search state (110), a connection request state (120) and a connection respond state (130).

6. Radio communication system (1,2) as claimed in claim 1, wherein the master unit (3) comprises a man-machine-interface (34) with at least two selection buttons and one or more arrow buttons.

7. Master unit (3) for use in a radiocommunication system (1,2) comprising the master unit (3) and at least one slave unit (4-7), which master unit (3) comprises a processor system (32) with a user interface application (81); a profile application (83,84); and a manager application (82) for—providing an interface to the user interface application (81); —managing the profile application (83,84); and—searching for and retrieving information from one or more slave units (4-7).

8. Processor system (32) for use in a master unit (3) of a radiocommunication system (1,2) comprising the master unit (3) and at least one slave unit (4-7), which processor system (32) comprises a user interface application (81); a profile application (83,84); and a manager application (82) for—providing an interface to the user interface application (81); —managing the profile application (83,84); and
searching for and retrieving information from one or more slave units (4-7).

9. Method for use in a master unit (3) of a radiocommunication system (1,2) comprising the master unit (3) and at least one slave unit (4-7), which master unit (3) comprises a processor system (32) with a user interface application (81) and a profile application (83,84), which method comprises the steps of—providing an interface to the user interface application (81); —managing the profile application (83,84); and—searching for and retrieving information from one or more slave units (4-7).

10. Processor program product to be run via a processor system (32) for use in a master unit (3) of a radiocommunication system (1,2) comprising the master unit (3) and at least one slave unit (4-7), which processor system (32) comprises a user interface application (81) and a profile application (83,84), which processor program product comprises the functions of—providing an interface to the user interface application (81); —managing the profile application (83,84); and—searching for and retrieving information from one or more slave units (4-7).
